(19) United States
(12) Patent Application Publication
(10) Pub. No.: US 2002/0036554 A1
(43) Pub. Date: Mar. 28, 2002

(54) Resonating apparatus in a dielectric substrate

(76) Inventors: Bumman Kim, Pohang-shi (KR); Junyoul Lim, Pohang-shi (KR); Seonghan Ryu, Pohang-shi (KR); Joung Hyun Yim, Pohang-shi (KR)

Correspondence Address: BACON & THOMAS, PLLC, 625 SLATERS LANE, FOURTH FLOOR, ALEXANDRIA, VA, 22314

(21) Appl. No.: 09/931,930

(22) Filed: Aug. 20, 2001

(30) Foreign Application Priority Data
Aug. 18, 2000 (KR) 2000-47786

(51) Int. Cl. H01P 7/10

(52) U.S. Cl. 333/219.1

(57) ABSTRACT

A resonating apparatus in accordance with the present invention comprises a dielectric resonator on a dielectric supporting substrate, a fluid dielectric membrane which overspreads the dielectric resonator, and a microstrip line which is arranged in the fluid substrate membrane so that it is coupled with the dielectric resonator. The resonating apparatus reduces the conductivity loss by lengthening the distance between the dielectric supporting substrate in the higher layer and the microstrip line in the lower layer when it is used in a multiplayer circuit or a MMIC. Further, the resonating apparatus increases the dielectric permittivity by using the dielectric resonator which has high dielectric permittivity and futher including the fluid dielectric membrane. In this way, the resonating apparatus obtains high Q.

### FIELD OF THE INVENTION

The present invention relates to a resonating apparatus in a dielectric substrate; and, more particularly, to a dielectric substrate resonator, which has a 3-dimensional structure for coupling with a microstrip line, for obtaining high Q by reducing dielectric loss and conductivity loss.

### BACKGROUND OF THE INVENTION

Recently, there is an increasing demand for communication system using microwave in mobile and satellite communication field. It is the trend of information communication field that devices are downsized and the communication frequency band moves to a higher frequency band. In personal mobile communication such as a PCS, satellite communication, or satellite broadcasting, a GHz frequency band is used for communication.

As an important device which is used as a component of an equipment using high frequency band, a microwave(its frequency ranges from 300 MHz to 300 GHz) dielectric device has been widely developed to be used as a dielectric resonating filter.

FIG. 1 illustrates a structure for coupling a microstrip line 12 with a dielectric resonator 14 adhered to a substrate. A dielectric resonator in accordance with the prior art, as shown in FIG. 1, is generally used in a multiplayer circuit and an MMIC circuit due to its simple structure.

The dielectric resonator 14 in accordance with the prior art is adhered to an upper side of a dielectric substrate 10, which is made of GaAs. The microstrip line 12, which is separated horizontally from the dielectric resonator 14, is arranged on the upper side of the dielectric substrate 10. When the length of the microstrip line 12 is ½λ, where λ is the wavelength of the microwave, and the microstrip line 12 and the dielectric substrate 10 are composed of gold and GaAs respectively, Q of the microstrip line 12 is calculated by Equation (1).

$${Q}_{u} = \frac{β}{2 ( {α}_{c} + {α}_{d} )} = 66.8 \qquad \text{Equation (1)}$$

where β is a propagation constant, α_{c} is an attenuation due to conductivity loss and α_{d} is the attenuation due to dielectric loss.

α_{c}, and α_{d} in Equation (1) are calculated by Equations (2) and (3), respectively.

$${α}_{c} = \frac{{R}_{s}}{{Z}_{0} W} \qquad \text{Equation (2)}$$

where R_{S}, Z_{O} and W are a surface resistance, a characterization impedance and a width of the microstrip line 12, respectively.

$${α}_{d} = \frac{{k}_{0} {ϵ}_{r} ( {ϵ}_{e} - 1 ) tan δ}{2 \sqrt{{ϵ}_{e}} ( {ϵ}_{r} - 1 )} \qquad \text{Equation (3)}$$

where εᵣ is a relative dielectric permittivity, εₑ is an effective dielectric permittivity and tanδ is a loss tangent of the dielectric substrate.

Referring to Equations (1) to (3), when Z_{O} is 50 Ω, tanδ is 0.0006 and the resonant frequency is 10 GHz, Q of the microstrip line is about 66.

According to Equation (1), Q of the dielectric resonator 14 depends on two factors, α_{c} and α_{d}, wherein α_{c} is inversely proportional to Z₀ and W. When the dielectric resonator 14 of the prior art is applied to a multiplayer circuit, a fluid dielectric substance is used to configure a microstrip line. In general, the height of the fluid dielectric substance, e.g., BCB, is limited to 40 μm. The smaller the height of the fluid dielectric substance is, the narrower the width of the microstrip line is. Therefore, Q becomes smaller.

Further, the conductivity loss of the microstrip line 12 affects the energy loss of the dielectric resonator 14. Accordingly, the dielectric resonating device in accordance with the prior art is not suitable for obtaining high Q that is required in microwave application.

### SUMMARY OF THE INVENTION

It is, therefore, an object of the present invention to provide a resonating apparatus that is suitable for a microwave application such as a multiplayer circuit and MMIC that requires high integrity and high Q.

In accordance with the present invention, there is provided a resonating apparatus comprising: a dielectric supporting substrate; a dielectric resonator which is formed on the dielectric supporting substrate; a fluid dielectric membrane which overspreads the dielectric resonator; and a microstrip line which is arranged in the fluid substrate membrane so that it is coupled with the dielectric resonator.

### BRIEF DESCRIPTION OF THE DRAWINGS

The above and other objects and features of the present invention will become apparent from the following description of preferred embodiments given in conjunction with the accompanying drawings, in which:

FIG. 1 illustrates a perspective view of a dielectric resonator in accordance with the prior art;

FIG. 2 illustrates a vertical cross-sectional view of a dielectric substrate resonator in accordance with an embodiment of the present invention;

FIG. 3 depicts horizontal cross-sectional views of dielectric substrate resonators of various shapes, in accordance with the present invention;

FIG. 4 depicts horizontal cross-sectional views of dielectric substrate resonators, which have connection lines to dielectric resonator substrates in accordance with the present invention;

FIG. 5 exhibits horizontal cross-sectional views of various structures for coupling dielectric resonators with microstrip lines in accordance with the present invention;

FIG. 6A exhibits a vertical cross-sectional view of a structure for coupling a dielectric resonator with a microstrip line in accordance with an embodiment of the present invention;

FIG. 6B charts a vertical cross-sectional view of a structure for coupling a dielectric resonator with a microstrip line in accordance with another embodiment of the present invention;

FIG. 7 illustrates a horizontal cross-sectional view of a filter that is constructed by using dielectric resonators in accordance with the present invention;

FIG. 8A illustrates a vertical cross-sectional view of a dielectric substrate resonator in accordance with the present invention for description of the resonant frequency of the dielectric resonator;

FIG. 8B illustrates a horizontal cross-sectional view of a structure of the dielectric substrate resonator shown in FIG. 8A;

FIG. 9A exhibits a relationship between the resonant frequency and the thickness of a dielectric resonator in accordance with the present invention;

FIG. 9B exhibits a relationship between the resonant frequency and the thickness of a dielectric supporting substrate in accordance with the present invention;

FIG. 9C exhibits a relationship between the resonant frequency and the thickness of a fluid dielectric membrane in accordance with the present invention;

FIG. 10 depicts changes of Q and the resonant frequency as functions of the change of the thickness of a fluid dielectric membrane in accordance with the present invention;

FIG. 11 depicts an energy distribution in a dielectric substrate resonator in accordance with the present invention;

FIG. 12 charts a vertical cross-sectional view of a dielectric substrate resonator without a dielectric resonator substrate in accordance with another embodiment of the present invention.

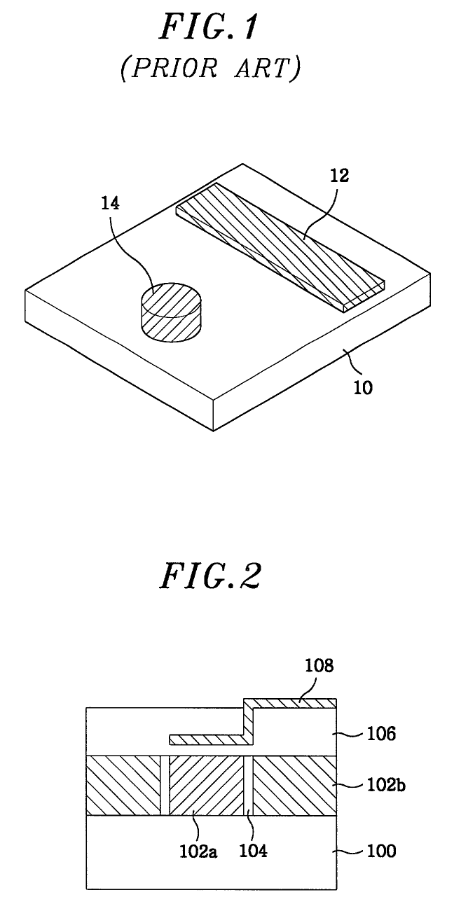

### DETAILED DESCRIPTION OF THE PREFERRED EMBODIMENTS

In the following, referring to the accompanying drawings, preferable embodiments in accordance with the present invention will be described in detail.

FIG. 2 illustrates a vertical cross-sectional view of a dielectric substrate resonator in accordance with an embodiment of the present invention.

As shown in FIG. 2, the dielectric substrate resonator in accordance with the embodiment of the present invention comprises a dielectric supporting substrate 100, a dielectric resonator 102a, a dielectric resonator substrate 102b, a fluid dielectric membrane 106 and a microstrip line 108.

In the dielectric substrate resonator shown in FIG. 2, the dielectric resonator 102a is formed on the dielectric supporting substrate 100, and the dielectric resonator 102a is composed of a material of higher dielectric permittivity than those of the dielectric supporting substrate 100 and the fluid dielectric membrane 106. For example, Teflon, GaAs and polymide can be used as materials of the dielectric supporting substrate 100, the dielectric resonator 102a, and the fluid dielectric membrane 106, respectively.

The dielectric resonator substrate 102b, which is also formed on the dielectric supporting substrate 100, is composed of the same material as the dielectric resonator 102a. In the embodiment of the present invention, the dielectric resonator substrate 102b surrounds the dielectric resonator 102a with a gap 104 therebetween. The gap 104 is filled with air whose dielectric permittivity is 1.

And, the fluid dielectric membrane 106 overspreads upper sides of the dielectric resonator 102a, the dielectric resonator substrate 102b and the gap 104 therebetween.

Further, the microstrip line 108, which is composed of conductive material, is arranged in the fluid dielectric membrane 106 so that it is coupled with the dielectric resonator 102a.

In order to reduce the conductivity loss in the microstrip line 108, the dielectric substrate resonator in accordance with the present invention further includes a ground line in each of the fluid dielectric membrane 106 and the dielectric supporting substrate 100.

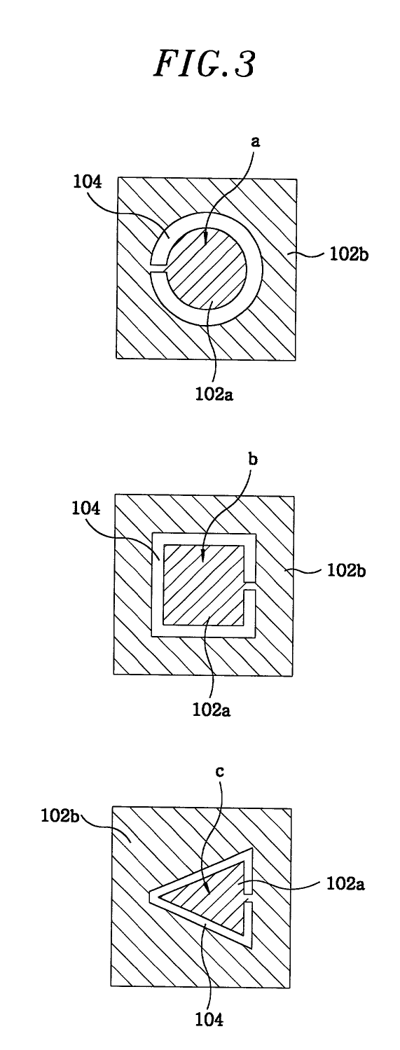

FIG. 3 illustrates horizontal cross-sectional views of dielectric substrate resonators, each of which has different shape from each other, in accordance with the present invention. Referring to FIG. 3, the cross-sectional shape of the dielectric resonator 102a can be a circle (a), a rectangle (b) or a triangle (c). However, the shape can be one of any polygonal shapes.

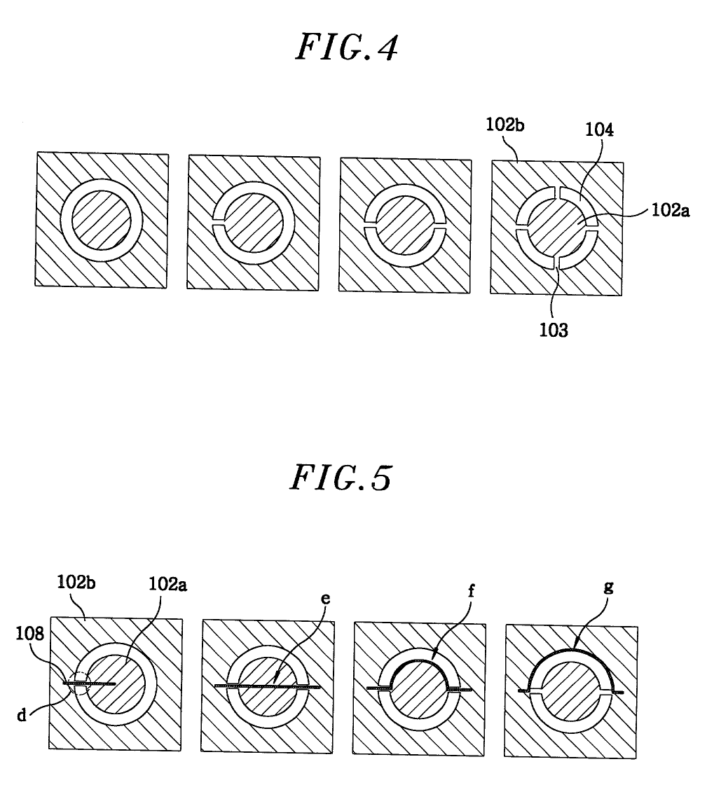

FIG. 4 shows horizontal cross-sectional views of dielectric resonators with dielectric resonator substrates in accordance with the present invention.

As shown in the first drawing of FIG. 4, the dielectric resonator 102a is formed by aquatinting the dielectric resonator substrate 102b, which is composed of GaAs, so that a gap 104 is formed therebetween.

Also, as shown in other drawings of FIG. 4, a connection line 103 can be formed between the dielectric resonator 102a and the dielectric resonator substrate 102b. The connection line 103 can be formed by aquatinting the dielectric resonator substrate 102b so that the gap 104 is formed in the shape of ring except the part of the connection line 103. In this case, the number of the connection lines 103 is at least more than one, and preferably the number and the position thereof are determined so that the dielectric resonator 102a and the dielectric resonator substrate 102b are connected to each other in stable state. Further, it is preferable that the number and the position of the connection lines 103 are adjusted according to environmental factors such as the solidity of the substrate.

FIG. 5 exhibits horizontal cross-sectional views of various structures for coupling dielectric resonators with microstrip lines in accordance with the present invention.

Referring to FIG. 5, the microstrip line 108 is formed in the shape of a straight line or a semicircle. When the microstrip line 108 has the shape of a straight line, it can be extended near to the center of the dielectric resonator 102a (d) or pass through the center thereof (e). When the microstrip line 108 has the shape of a semicircle, it can be arranged following the inscribed circle (f) or the circumference of the dielectric resonator 102a. In this way, the microstrip line 108 can obtain different degrees of coupling with the dielectric resonator 102a by changing the shape and the position thereof.

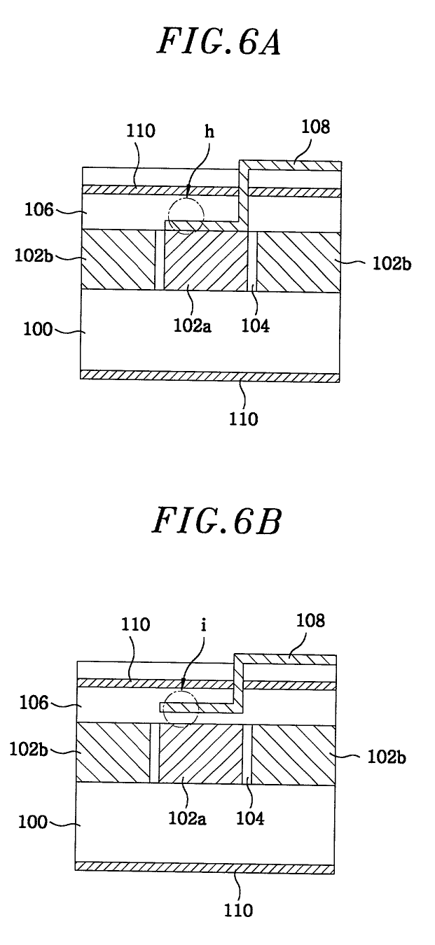

FIGS. 6A and 6B show vertical cross-sectional views of structures for coupling of dielectric resonators with microstrip lines.

As illustrated in FIG. 6A, in order to increase the degree of coupling, the microstrip line 108 is arranged on the upper side of the dielectric resonator 102a so that they come into contact with each other. Or, the microstrip line 108 is formed in a position separated from the upper side of the dielectric resonator 102a to lower the degree of coupling as shown in FIG. 6B. In this way, the degree of coupling thereof can be adjusted. The dielectric substrate resonator in accordance with the present invention is surrounded by a ground plane 110.

FIG. 7 exemplifies a band-pass filter which is constructed by combining two dielectric resonators in accordance with the present invention. When using dielectric resonators in accordance with the present invention, it is possible to manufacture a filter that has high Q.

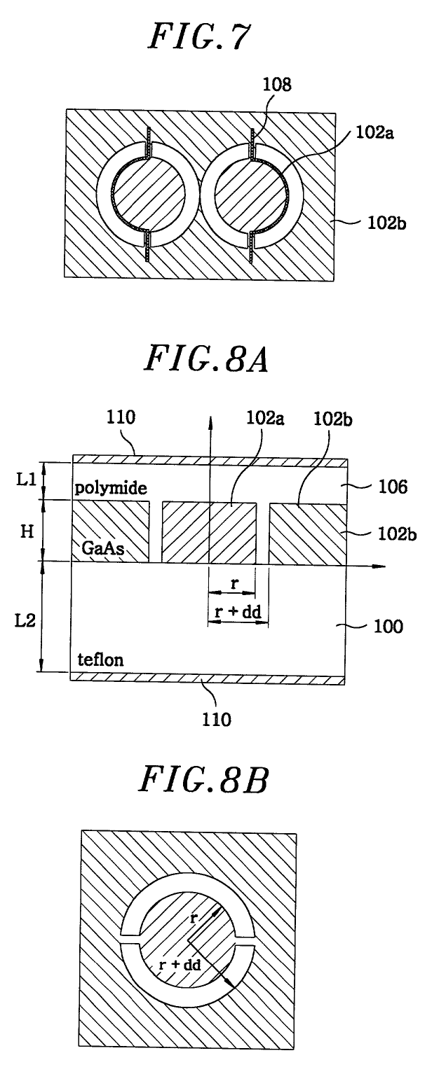

For the purpose of explanation on the resonant frequency of a dielectric resonator in accordance with the present invention, FIGS. 8A and 8B show cross-sectional views of vertical and horizontal structure of the dielectric resonator. In the following, referring to FIGS. 8A and 8B, the resonant frequency of a dielectric substrate resonator in accordance with the present invention will be described in detail.

As a method for computing resonant frequencies of dielectric resonators, Itoh & Rudokas' method can be used. The Itoh & Rudokas' method, which is described in T. Itoh and R. S. Rudokas, “New Method for Computing the Resonant Frequencies of Dielectric Resonators”, IEEE Transactions on Microwave Theory and Technology, MMT-25, No. 12, pp. 52-54 (January 1977), calculates the resonant frequencies under the boundary condition of each area which a dielectric resonator is divided into. The boundary condition equations according to the Itoh & Rudokas' method are expressed in Equations (4) and (5).

$$\begin{matrix}β H = q π + {tan}^{- 1} [ \frac{{α}_{1}}{β} coth ( {α}_{1} {L}_{1} ) ] + {tan}^{- 1} [ \frac{{α}_{2}}{β} coth ( {α}_{2} {L}_{2} ) ] & \text{Equation (4)} \\ \frac{{J}_{0} ( {k}_{r1} r )}{{J}_{1} ( {k}_{r1} r )} = - \frac{{k}_{r2} r}{{k}_{r1} r} \frac{{K}_{0} ( {k}_{r2} r )}{{K}_{1} ( {k}_{r2} r )} & \text{Equation}\end{matrix}$$

where L₁ is a thickness of the fluid dielectric membrane 106, L₂ is a thickness of the dielectric supporting substrate 100, H is a height of the dielectric resonator 102a, and r is a radius of the dielectric resonator 102b.

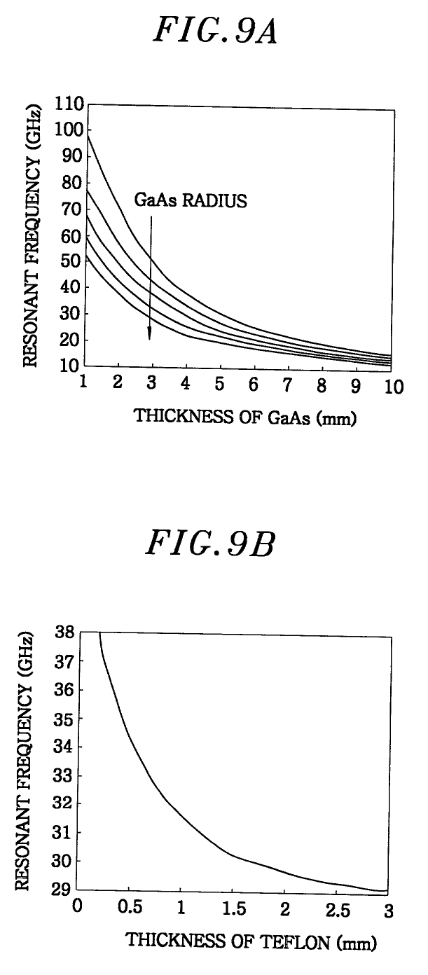

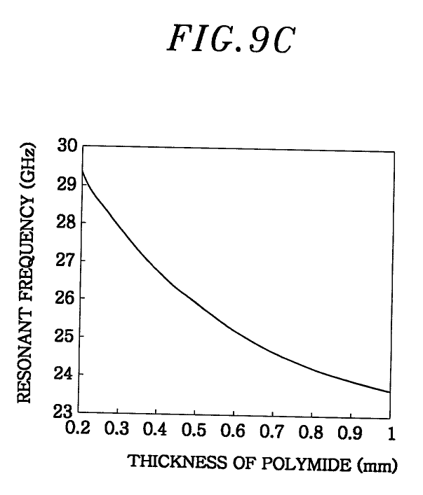

The resonant frequency can be obtained by resolving Equations (4) and (5) by using numerical analysis. FIGS. 9A to 9C show the relationships of the resonant frequency with the thickness of each of the dielectric resonator 102a, the dielectric supporting substrate 100 and the fluid dielectric membrane 106, respectively.

FIGS. 9A to 9C show that the resonant frequency decreases as the thickness of each of the dielectric resonator 102a (GaAs), the dielectric supporting substrate 100 (Teflon) and the fluid dielectric membrane 106 (polymide) increases. Further, FIG. 9A illustrates that the resonant frequency decreases as the radius of the dielectric resonator 102a (GaAs) increases.

Therefore, the optimal resonant frequency can be obtained by adjusting the thickness of each of the dielectric resonator 102a, the dielectric supporting substrate 100 and the fluid dielectric membrane 106. Also, the radius of the dielectric resonator 102a affects the resonant frequency.

Q of the microstrip line 108 in the dielectric substrate resonator in accordance with the present invention is computed by using Equation (6).

$$\frac{1}{{Q}_{u}} = \frac{1}{{Q}_{r}} + \frac{1}{{Q}_{c}} + \frac{1}{{Q}_{d}} \approx \frac{1}{{Q}_{c}} + \frac{1}{{Q}_{d}} \qquad \text{Equation (6)}$$

where Qᵤ is an unloaded Q of the microstrip line 108, Qᵣ is Q by radiation loss, Q_{c} is Q by conductivity loss and Q_{d} is Q by dielectric loss.

Qᵣ is negligible when the dielectric substrate resonator is surrounded by metallic wall which plays a role of ground, which means that Qᵤ depends on Q_{c} and Q_{d} as shown in Equation (6). Q_{d} is the reciprocal of loss tangent and has a value of about 1667 when the dielectric resonator substrate 102b is composed of GaAs. Q_{c} is Q by loss due to the skin depth of the microstrip line 108.

The dielectric substrate resonator in accordance with the present invention, when it is applied to a multiplayer circuit, MMIC or filter, reduces a conductivity loss of the microstrip line by lengthening the distance between the microstrip line in the lower layer and the dielectric substrate in the higher layer. Further, the dielectric substrate resonator reduces a dielectric loss of the dielectric resonator by employing the dielectric resonator substrate, which has a high dielectric permittivity, in the circumference of the dielectric resonator. According to Equation (6), the lower a conductivity loss and a dielectric loss are, the higher Q is.

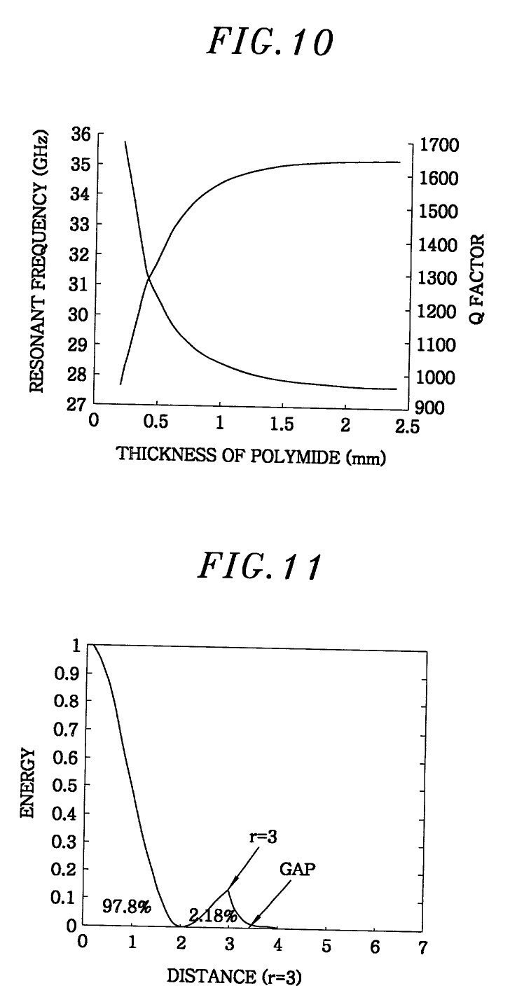

FIG. 10 exhibits changes of the unloaded Q and the resonant frequency of the microstrip line 108 as functions of the change of the thickness of the fluid dielectric membrane 106 in accordance with the present invention. As shown in FIG. 10, Qᵤ has the value ranging from 900 to 1000 when the thickness of polymide ranges from 0.2 mm to 0.3 mm.

FIG. 11 illustrates an energy distribution in the dielectric resonator 102a, the radius of which is 3 mm, in accordance with the present invention. Referring to FIG. 11, it is found that almost all of the energy is distributed within the distance of 3.5 mm from the center of the dielectric resonator 102a. That is, when the gap 104 between the dielectric resonator and the dielectric resonator substrate 102b is more than 0.5 mm, the most part of the energy is distributed near the dielectric resonator, which results in lower loss of energy.

Therefore, the dielectric substrate resonator in accordance with the present invention reduces the energy loss by adjusting the gap between the dielectric resonator and the dielectric resonator substrate.

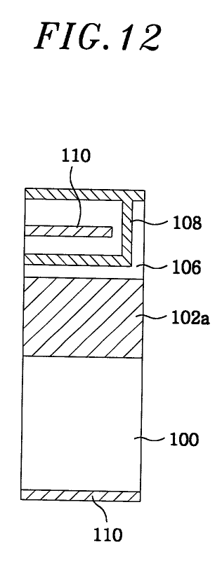

FIG. 12 charts a vertical cross-sectional view of a dielectric resonator without a dielectric resonator substrate in accordance with another embodiment of the present invention.

As shown in FIG. 12, the dielectric resonator in accordance with the another embodiment of the present invention comprises a dielectric supporting substrate 100, a dielectric resonator 102 which has higher dielectric permittivity than that of the dielectric supporting substrate 100 and is formed thereon, a fluid dielectric membrane 106 which overspreads the dielectric resonator 102, and a microstrip line 108 which is arranged in the fluid dielectric membrane 106 so that the microstrip line 108 is coupled with the dielectric resonator 102.

The dielectric resonator without a dielectric resonator substrate in accordance with the another embodiment of the present invention has an advantage that it is used to miniaturize devices such as a filter and an oscillator.

While the invention has been shown and described with respect to the preferred embodiments, it will be understood by those skilled in the art that various changes and modifications may be made without departing from the spirit and scope of the invention as defined in the following claims.

What is claimed is:

1. A resonating apparatus comprising:
a dielectric supporting substrate;
a dielectric resonator which is formed on the dielectric supporting substrate;
a fluid dielectric membrane which overspreads the dielectric resonator; and
a microstrip line which is arranged in the fluid dielectric membrane so that the dielectric resonator is coupled with the dielectric resonator.

2. The apparatus of claim 1, further comprising:
a dielectric resonator substrate which surrounds the dielectric resonator so that a gap is formed therebetween.

3. The apparatus of claim 2, wherein the fluid dielectric membrane overspreads the dielectric resonator, the dielectric resonator substrate and the gap therebetween.

4. The apparatus of claim 1, wherein the dielectric resonator is formed in the shape of a circle or a polygon.

5. The apparatus of claim 1, further comprising:
equal to or more than one dielectric connection line which connects the dielectric resonator to the dielectric resonator substrate.
